(19) United States
(12) Patent Application Publication
(10) Pub. No.: US 2026/0084505 A1
(43) Pub. Date: Mar. 26, 2026

(54) DOOR BODY FOR VEHICLE

(71) Applicants: Hyundai Motor Company, Seoul (KR); Kia Corporation, Seoul (KR)

(72) Inventor: Sang Jin LEE, Hwaseong-Si (KR)

(73) Assignees: Hyundai Motor Company, Seoul (KR); Kia Corporation, Seoul (KR)

(21) Appl. No.: 19/186,294

(22) Filed: Apr. 22, 2025

(30) Foreign Application Priority Data
Sep. 23, 2024 (KR) 10-2024-0128421

(51) Int. Cl. B60J 10/76; B60J 5/04

(52) U.S. Cl. CPC B60J 10/76; B60J 5/0402

(57) ABSTRACT

A door body for a vehicle, includes a door panel including an opening defined in a center portion of the door panel; and a window frame integrally connected to the door panel, and including a first extension portion and a second extension portion extending from the first extension portion, wherein the first and second extension portions define a glass opening, wherein the door panel and the window frame form a unitary one-piece structure.

### CROSS-REFERENCE TO RELATED APPLICATION

The present application claims priority to Korean Patent Application No. 10-2024-0128421, filed on Sep. 23, 2024, the entire contents of which is incorporated herein for all purposes by this reference.

### BACKGROUND OF THE PRESENT DISCLOSURE

### Field of the Present Disclosure

The present disclosure relates to a door body for a vehicle, and more particularly, to a door body for a vehicle which may be easily manufactured by casting.

### Description of Related Art

A vehicle door may include a door body, and a plurality of sealing components mounted on edges of the door body.

The door body may include a door panel, and a window frame connected to the door panel. The window frame may have a glass opening defined in a center portion thereof, and the glass opening may be opened or closed by a door glass. The door panel may have an opening defined in a center portion thereof, and various components such as a door glass regulator may be disposed in the opening of the door panel.

The plurality of sealing components may include a glass run mounted on edges of the window frame, and an internal belt weatherstrip mounted on a top edge of the door panel.

A door body according to the related art may include a window frame, a door panel, a hinge reinforcement, and a latch reinforcement individually manufactured by pressing. Since the window frame, the hinge reinforcement, and the latch reinforcement are fixed to the door panel using fasteners, welding, and/or the like, the number of joints may be relatively increased, an assembly process may be complex, and the quality of assembly may be reduced due to manufacturing errors, assembly errors, and the like.

Furthermore, as individual components of the related art door body are formed by pressing, it may be difficult to ensure formability, so that the degree of freedom in shaping and design may be relatively low. Since a plurality of reinforcement members need to be attached to increase strength, the manufacturing cost of the door body may be relatively increased.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a door body for a vehicle which may be easily manufactured by casting.

According to an aspect of the present disclosure, a door body for a vehicle may include: a door panel including an opening defined in a center portion of the door panel; and a window frame integrally connected to the door panel, and including a first extension portion and a second extension portion extending from the first extension portion, wherein the first and second extension portions define a glass opening. The door panel and the window frame may form a unitary one-piece structure.

The door panel may include a plurality of panel-side ribs disposed on the periphery of the opening, and the plurality of panel-side ribs may extend radially from the center portion of the opening.

The door panel may further include a plurality of panel-side protrusions disposed on the periphery of the opening. Each panel-side protrusion may protrude from an outboard-side surface of the door panel toward the exterior of the vehicle.

At least some of the plurality of panel-side protrusions may be individually connected to the plurality of panel-side ribs.

The door panel may further include an extension rib extending along the periphery of the opening.

The plurality of panel-side ribs may be connected to the extension rib.

The window frame may further include a plurality of frame-side protrusions disposed on the periphery of the glass opening. Each frame-side protrusion may protrude from an outboard-side surface of the window frame toward the exterior of the vehicle.

The window frame may further include a plurality of frame-side ribs disposed on the periphery of the glass opening.

The plurality of frame-side ribs may include a plurality of first frame-side ribs disposed on the first extension portion, and a plurality of second frame-side ribs disposed on the second extension portion. Each first frame-side rib may include an X-like shape, and each second frame-side rib may include a straight shape extending in a longitudinal direction of the vehicle.

At least some of the plurality of frame-side protrusions may be individually connected to the first frame-side ribs.

At least some of the plurality of frame-side protrusions may be individually connected to the second frame-side ribs.

The door body may further include: a partition rib provided on a portion of the door body; and a first section and a second section partitioned by the partition rib. A thickness of the second section may be greater than the thickness of the first section.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a door body for a vehicle according to an exemplary embodiment of the present disclosure, which is viewed from the exterior of the vehicle;

FIG. 2 illustrates an enlarged view of portion A of FIG. 1;

FIG. 3 illustrates a cross-sectional view, taken along line B-B of FIG. 2;

FIG. 4 illustrates a cross-sectional view, taken along line C-C of FIG. 2;

FIG. 5 illustrates a cross-sectional view, taken along line D-D of FIG. 2;

FIG. 6 illustrates a perspective view of an upper portion of a door panel in a door body for a vehicle according to an exemplary embodiment of the present disclosure;

FIG. 7 illustrates an enlarged view of portion E of FIG. 6;

FIG. 8 illustrates a cross-sectional view, taken along line F-F of FIG. 7;

FIG. 9 illustrates an enlarged view of portion G of FIG. 6;

FIG. 10 illustrates an enlarged view of portion H of FIG. 6;

FIG. 11 illustrates a cross-sectional view, taken along line J-J of FIG. 1;

FIG. 12 illustrates a cross-sectional view, taken along line K-K of FIG. 1;

FIG. 13 illustrates a cross-sectional view, taken along line L-L of FIG. 1; and

FIG. 14 illustrates a cross-sectional view, taken along line M-M of FIG. 1.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In the drawings, the same reference numerals will be used throughout to designate the same or equivalent elements. Furthermore, a detailed description of well-known techniques associated with the present disclosure will be ruled out in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, include the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

In the specification, the term “inner” refers to a direction toward the center portion of an opening of a window frame, and the term “outer” refers to a direction away from the center portion of the opening of the window frame. Furthermore, the term “inboard side” refers to a direction toward an internal space of a vehicle, and the term “outboard side” refers to a direction toward an external space of the vehicle.

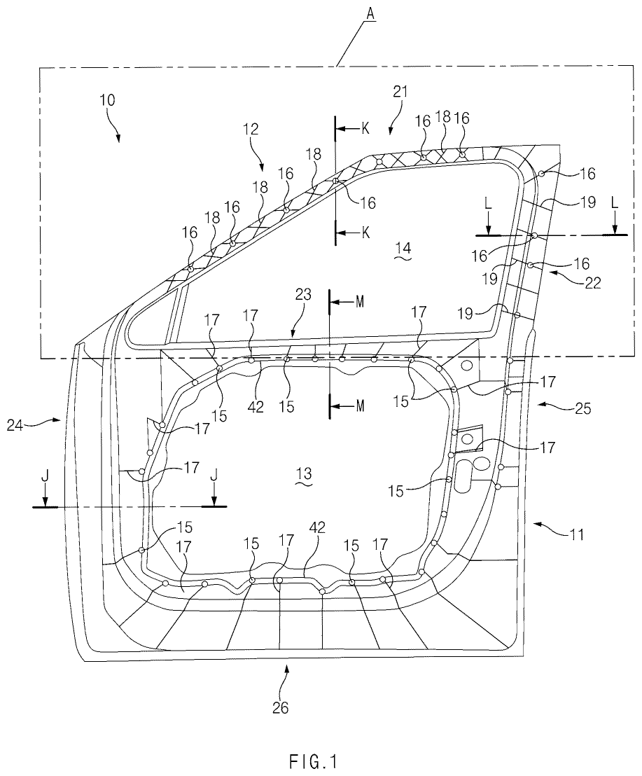

FIG. 1 illustrates a door body for a vehicle according to an exemplary embodiment of the present disclosure, which is viewed from the exterior of the vehicle. Referring to FIG. 1, a door body 10 for a vehicle according to an exemplary embodiment of the present disclosure may include a door panel 11, and a window frame 12 integrally connected to the door panel 11.

The door panel 11 and the window frame 12 may be made of an aluminum material, and the door panel 11 and the window frame 12 may be manufactured by casting to form a unitary one-piece structure of the door panel 11 and the window frame 12. As the door panel 11 and the window frame 12 form a unitary one-piece structure, the number of assembled components of a vehicle door may be reduced so that variation in assembly tolerance may be reduced, and the degree of freedom in shaping and design may be increased, and thus the door performance may be improved.

Referring to FIG. 1, the door panel 11 may include an opening 13 defined in a center portion of the door panel 11, and various components such as a door glass regulator may be disposed in the opening 13 of the door panel 11.

Referring to FIG. 1, the door panel 11 may include an upper portion 23 by which a glass opening 14 of the window frame 12 and the opening 13 of the door panel 11 are partitioned therebetween, a front portion 24 facing the front of the vehicle, a rear portion 25 facing the rear of the vehicle, and a lower portion 26 facing the bottom portion of the vehicle. The upper portion 23, the front portion 24, the rear portion 25, and the lower portion 26 may define the opening 13 by surrounding the opening 13.

The door panel 11 may include an outboard-side surface facing the exterior of the vehicle, and an inboard-side surface facing the interior of the vehicle.

Referring to FIG. 1, the door panel 11 may include a plurality of panel-side protrusions 15 disposed on the periphery of the opening 13. The plurality of panel-side protrusions 15 may be disposed on the upper portion 23, the front portion 24, the rear portion 25, and the lower portion 26 of the door panel 11 along the periphery of the opening 13.

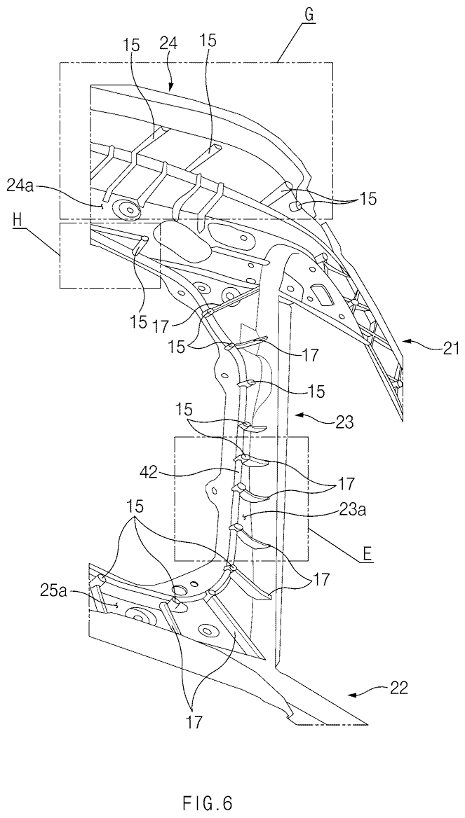

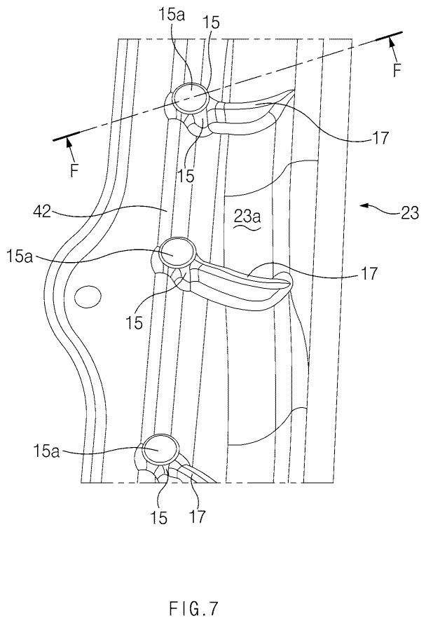

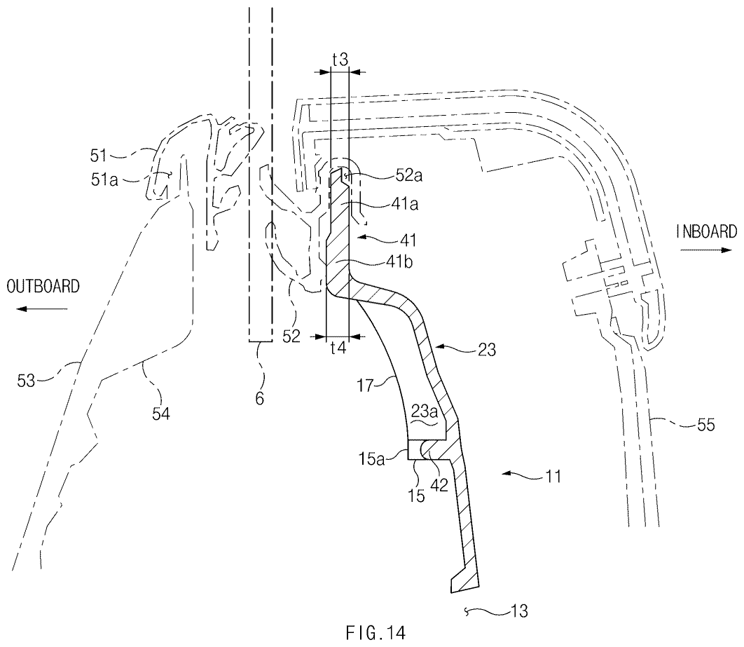

Referring to FIGS. 6 and 14, each panel-side protrusion 15 may protrude from the outboard-side surface of the door panel 11 toward the exterior of the vehicle. Referring to FIGS. 7 and 14, each panel-side protrusion 15 may include a flat surface 15a facing the exterior of the vehicle. For example, the flat surface 15a may include a shape of a circle. Stiffness of the door panel 11 may be improved by the plurality of panel-side protrusions 15. When the door body 10 is manufactured by casting, ejector pins of a die may push the flat surfaces 15a of the panel-side protrusions 15, respectively, so that ejection of the door body 10 may be facilitated.

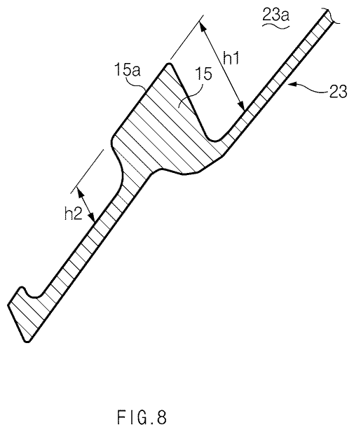

The plurality of panel-side protrusions 15 may have different protrusion heights according to the positions thereof. Referring to FIG. 8, the panel-side protrusions 15 provided on the upper portion 23 of the door panel 11 may have different protrusion heights h1 and h2 according to the positions thereof. For example, a protrusion height h1 of the panel-side protrusion 15 protruding from a bottom surface of a channel 23a and a protrusion height h2 of the panel-side protrusion 15 protruding from a bottom surface of an edge portion of the upper portion 23 adjacent to the channel 23a may be different from each other.

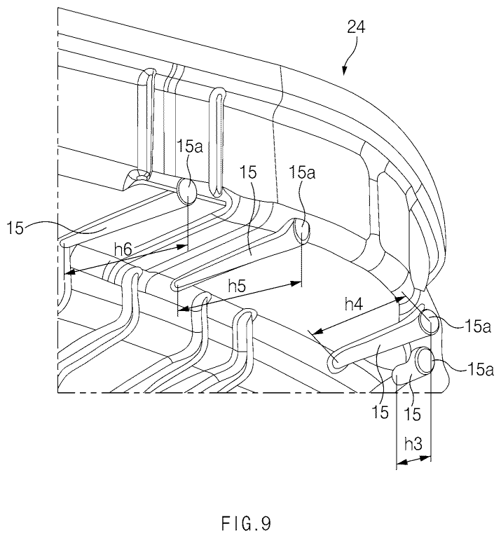

Referring to FIG. 9, the panel-side protrusions 15 provided on an edge portion of the front portion 24 of the door panel 11 may have different protrusion heights h3, h4, h5, and h6 according to the positions thereof.

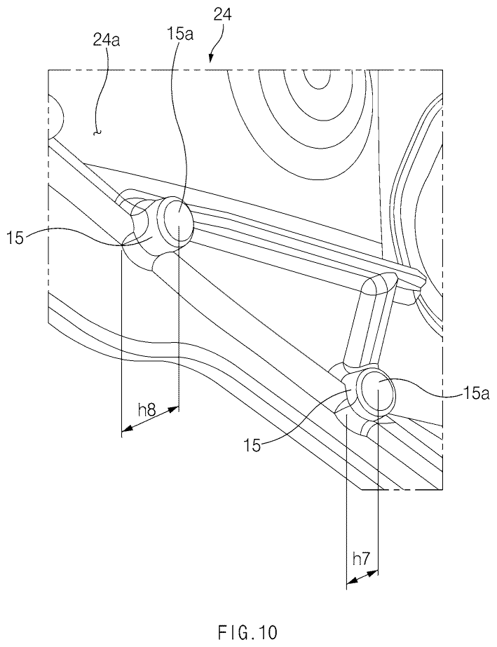

Referring to FIG. 10, the panel-side protrusions 15 provided on a channel 24a of the front portion 24 of the door panel 11 may have protrusion heights h7 and h8 lower than the protrusion heights h3, h4, h5, and h6 of the panel-side protrusions 15 provided on the edge portion of the front portion 24.

The door panel 11 may include a channel extending along the periphery of the opening 13, and the channel may be open to the exterior of the vehicle. The lower portion 26 of the door panel 11 may include a channel which is open to the exterior of the vehicle. Referring to FIG. 6, the upper portion 23 of the door panel 11 may include the channel 23a which is open to the exterior of the vehicle, the front portion 24 of the door panel 11 may include the channel 24a which is open to the exterior of the vehicle, and the rear portion 25 of the door panel 11 may include a channel 25a which is open to the exterior of the vehicle.

Referring to FIG. 1, the door panel 11 may include a plurality of panel-side ribs 17 disposed on the periphery of the opening 13, and each panel-side rib 17 may be disposed on the outboard-side surface of the door panel 11. The plurality of panel-side ribs 17 may be provided on the upper portion 23, the front portion 24, the rear portion 25, and the lower portion 26 of the door panel 11, and the plurality of panel-side ribs 17 may extend radially from the center portion of the opening 13.

At least some panel-side protrusions 15 of the plurality of panel-side protrusions 15 may be individually connected to the plurality of panel-side ribs 17. Accordingly, the stiffness of the door panel 11 may be improved by the plurality of panel-side ribs 17 and the plurality of panel-side protrusions 15. When the door body 10 is cast, a molten material may flow rapidly and uniformly along the plurality of panel-side ribs 17 so that castability of the door body 10 may be improved.

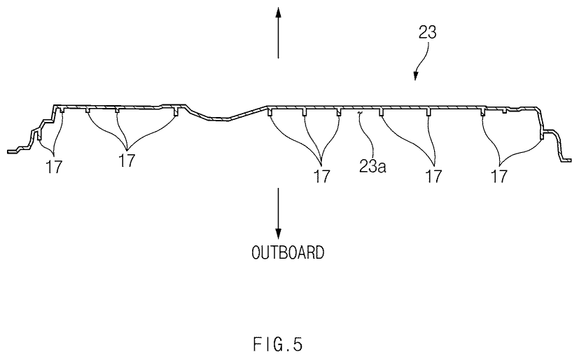

Referring to FIG. 5, the upper portion 23 of the door panel 11 may include the channel 23a which is open to the exterior of the vehicle, and each panel-side rib 17 may protrude from the bottom surface of the channel 23a toward the exterior of the vehicle.

Referring to FIG. 1, the door panel 11 may include an extension rib 42 extending along the periphery of the opening 13. The extension rib 42 may extend along the upper portion 23, the front portion 24, the lower portion 26, and the rear portion 25 of the door panel 11. The extension rib 42 may be disposed on the outboard-side surface of the door panel 11, and the plurality of panel-side ribs 17 may be connected to the extension rib 42. Accordingly, the extension rib 42 may connect the plurality of panel-side ribs 17 so that the stiffness of the door panel 11 may be improved by the extension rib 42 and the plurality of panel-side ribs 17.

Referring to FIG. 1, the window frame 12 may include the glass opening 14 in a center portion of the window frame 12, and the glass opening 14 may be opened or closed by a door glass. The window frame 12 may include a plurality of frame-side protrusions 16 disposed on the periphery of the glass opening 14.

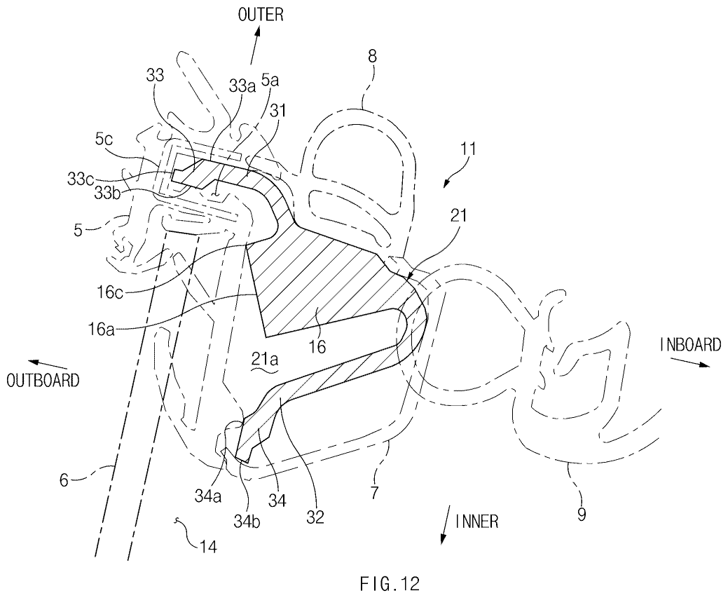

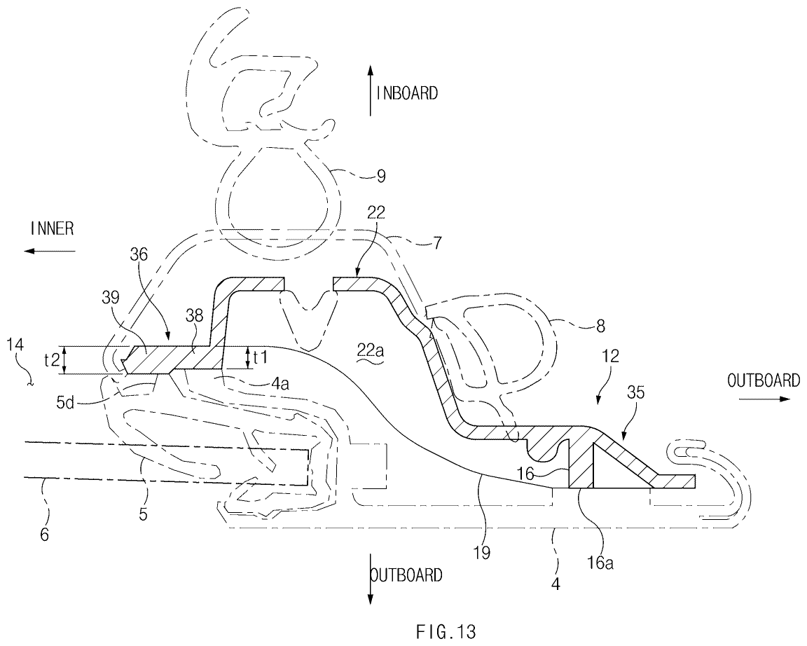

Referring to FIG. 12, and FIG. 13, the window frame 12 may include a channel which is open to the exterior of the vehicle, and each frame-side protrusion 16 may protrude from an outboard-side surface of the window frame 12 toward the exterior of the vehicle and include a flat surface 16a facing the exterior of the vehicle.

The plurality of frame-side protrusions 16 may have different protrusion heights according to the positions thereof. For example, the flat surface 16a may include a shape of a circle. Stiffness of the window frame 12 may be improved by the plurality of frame-side protrusions 16. When the door body 10 is manufactured by casting, ejector pins of a die may push the flat surfaces 16a of the frame-side protrusions 16, respectively, so that ejection of the door body 10 may be facilitated.

Referring to FIG. 1, the window frame 12 may include a first extension portion 21 and a second extension portion 22 defining the glass opening 14. The first extension portion 21 may include a shape matching the front side profile (a front window glass, a roof, and the like) of the vehicle, and the second extension portion 22 may extend vertically to match a center pillar of the vehicle. Referring to FIG. 1, the window frame 12 may include a plurality of frame-side ribs 18 and 19 disposed on the periphery of the glass opening 14.

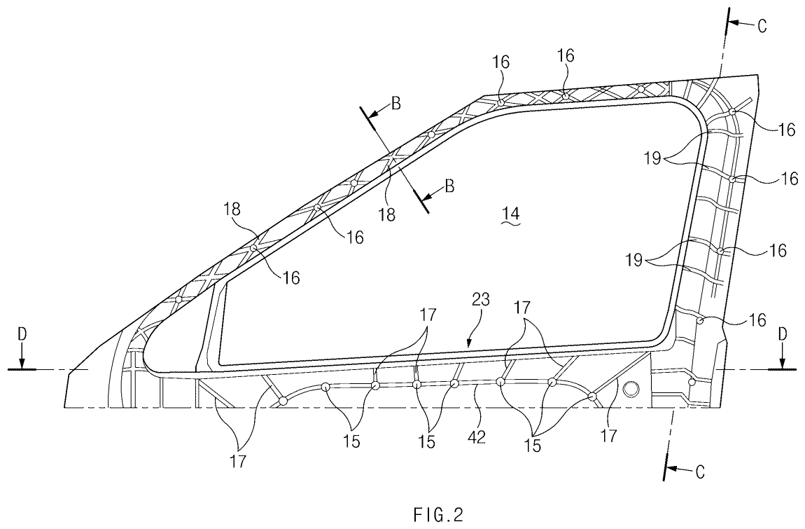

Referring to FIG. 2, the plurality of frame-side ribs 18 and 19 may include a plurality of first frame-side ribs 18 disposed on an outboard-side surface of the first extension portion 21 of the window frame 12, and a plurality of second frame-side ribs 19 disposed on an outboard-side surface of the second extension portion 22 of the window frame 12.

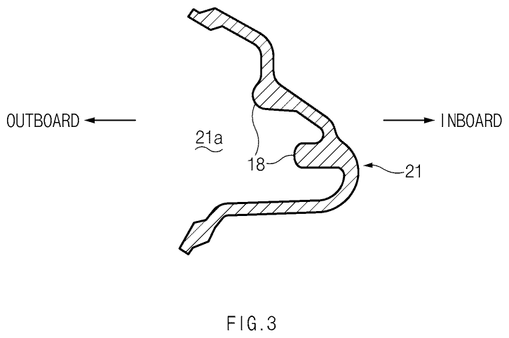

Referring to FIG. 1 and FIG. 2, each first frame-side rib 18 may include an X-like shape, and the plurality of first frame-side ribs 18 may be spaced apart from each other in a longitudinal direction of the first extension portion 21. Referring to FIG. 3, the first extension portion 21 may include a channel 21a which is open to the exterior of the vehicle. Each first frame-side rib 18 may protrude from a bottom surface of the channel 21a toward the exterior of the vehicle.

Stiffness of the first extension portion 21 of the window frame 12 may be improved by the plurality of first frame-side ribs 18, and deformation of the first extension portion 21 of the window frame 12 may be prevented during high-speed driving of the vehicle. When the door body 10 is cast, a molten material may flow rapidly and uniformly along the plurality of first frame-side ribs 18 so that castability of the first extension portion 21 of the window frame 12 may be improved. At least some frame-side protrusions 16 of the plurality of frame-side protrusions 16 may be individually connected to the first frame-side ribs 18. At least some frame-side protrusions 16 may be located at the center portion of at least some first frame-side ribs 18.

Each second frame-side rib 19 may include a straight shape extending in a longitudinal direction of the vehicle. Stiffness of the second extension portion 22 of the window frame 12 may be improved by the plurality of second frame-side ribs 19. At least some frame-side protrusions 16 of the plurality of frame-side protrusions 16 may be individually connected to the second frame-side ribs 19.

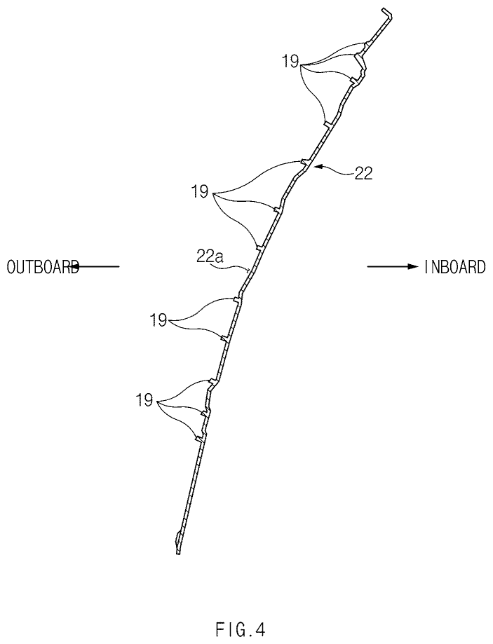

Referring to FIG. 4, the second extension portion 22 may include a channel 22a which is open to the exterior of the vehicle, and each second frame-side rib 19 may protrude from a bottom surface of the channel 22a toward the exterior of the vehicle.

In a door body according to the related art, individual components may be manufactured by pressing, so formability thereof may be relatively poor and the degree of freedom in design may be relatively reduced. Accordingly, when a hinge bracket is mounted on a door panel, an undesirable gap between the hinge bracket and a front portion of the door panel may be generated. On the other hand, the door body 10 according to an exemplary embodiment of the present disclosure may be manufactured by casting so that formability thereof may be satisfactory and the degree of freedom in design may be relatively increased. When a hinge bracket is mounted on the door panel 11 of the door body 10, an undesirable gap between the hinge bracket and the door panel 11 may be prevented.

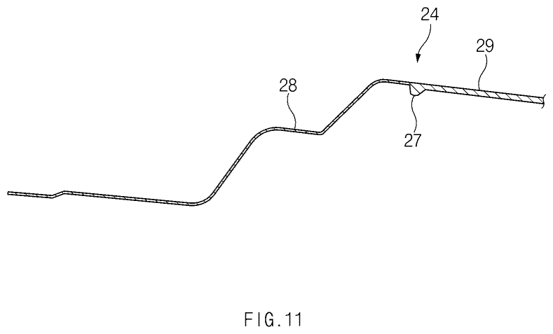

According to an exemplary embodiment of the present disclosure, a thickness of a section of the door body 10 on which other components (for example, a hinge bracket, a latch, and the like) are mounted may be greater than the thickness of the other section. Referring to FIG. 11, the door body 10 may further include a partition rib 27 disposed on a portion of the door body 10, and a first section 28 and a second section 29 are partitioned by the partition rib 27. A thickness of the second section 29 may be greater than the thickness of the first section 28, the first section 28 refers to most of the door body 10, and the second section 29 refers to a section of the door body 10 on which the other components are mounted. Referring to FIG. 11, the partition rib 27 may be disposed on the front portion 24 of the door panel 11, and the first section 28 and the second section 29 may have different thicknesses with respect to the partition rib 27. The hinge bracket may be mounted on the second section 29, and the thickness of the second section 29 may be greater than the thickness of the first section 28. Accordingly, mounting stiffness of the hinge bracket and stiffness of the door body 10 may be improved.

Referring to FIG. 12, and FIG. 13, a glass run 5 may be mounted along the first extension portion 21 and the second extension portion 22 of the window frame 12. The glass run 5 may provide a seal between a door glass 6 and the window frame 12.

Referring to FIG. 12, the glass run 5 may include a mounting groove 5a provided in an external peripheral edge portion of the glass run 5, and the glass run 5 may include an insert 5c adjacent to the mounting groove 5a. The glass run 5 may provide a seal between the door glass 6 and the first extension portion 21 of the window frame 12. An internal cover 7 may be mounted on an inboard-side surface of the first extension portion 21 of the window frame 12, and the internal cover 7 may cover the inboard-side surface of the first extension portion 21 of the window frame 12.

A door weatherstrip 8 may be mounted on the window frame 12. When the vehicle door closes an opening of a vehicle body, the door weatherstrip 8 may tightly contact with the vehicle body so that the vehicle door and the vehicle body may be sealed by the door weatherstrip 8. A vehicle body weatherstrip 9 may be mounted on the vehicle body. When the vehicle door closes the opening of the vehicle body, the vehicle body weatherstrip 9 may tightly contact with the internal cover 7 so that the vehicle body and the vehicle door may be sealed by the vehicle body weatherstrip 9.

Referring to FIG. 12, the first extension portion 21 of the window frame 12 may include an external peripheral edge portion 31 extending in an external direction of the window frame 12 from the frame-side portion 16, an internal peripheral edge portion 32 extending in an internal direction of the window frame 12 from the frame-side portion 16, an external support protrusion 33 disposed on the external peripheral edge portion 31, and an internal support protrusion 34 disposed on the internal peripheral edge portion 32.

Referring to FIG. 12, the external support protrusion 33 of the first extension portion 21 may be fitted into the mounting groove 5a of the glass run 5. According to an exemplary embodiment of the present disclosure, the external support protrusion 33 may include a first support surface 33a facing the external side of the window frame 12, a second support surface 33b facing the internal side of the window frame 12, and a third support surface 33c facing the outboard side of the window frame 12. The external support protrusion 33 may make surface-contact with the mounting groove 5a of the glass run 5 in three directions through the first support surface 33a, the second support surface 33b, and the third support surface 33c. Accordingly, the external support protrusion 33 and the mounting groove 5a of the glass run 5 may be matched exactly so that the external support protrusion 33 may firmly support the mounting groove 5a of the glass run 5. A thickness of the external support protrusion 33 may be greater than the thickness of the external peripheral edge portion 31. For example, the external support protrusion 33 may include a parallelogram cross section.

Referring to FIG. 12, the internal support protrusion 34 of the first extension portion 21 may include a first support surface 34a facing the outboard side of the window frame 12, and a second support surface 34b facing the internal side of the window frame 12. The first support surface 34a of the internal support protrusion 34 may support an internal peripheral edge portion of the glass run 5, and the second support surface 34b of the internal support protrusion 34 may support an internal peripheral edge portion of the internal cover 7. The internal support protrusion 34 may contact with the glass run 5 and the internal cover 7 through the first support surface 34a and the second support surface 34b so that the first extension portion 21 of the window frame 12 may firmly support the glass run 5 and the internal cover 7.

Referring to FIG. 12, at least a portion 16c of the flat surface 16a of the frame-side protrusion 16 of the first extension portion 21 may contact with an inboard-side surface of the glass run 5, and accordingly the first extension portion 21 of the window frame 12 may firmly support the glass run 5.

As described above, the first extension portion 21 of the window frame 12 may be exactly matched to the glass run 5 and the internal cover 7 through the external support protrusion 33, the internal support protrusion 34, and the frame-side protrusion 16 so that the first extension portion 21 of the window frame 12 may firmly support the glass run 5 and the internal cover 7.

Referring to FIG. 13, the glass run 5 may be supported to the second extension portion 22 of the window frame 12, and the glass run 5 may provide a seal between the window frame 12 and the door glass 6. The internal cover 7 may be mounted on an inboard-side surface of the second extension portion 22 of the window frame 12, and the internal cover 7 may cover the inboard-side surface of the second extension portion 22 of the window frame 12.

A frame molding 4 may be mounted on the outboard-side surface of the second extension portion 22 of the window frame 12, and the frame molding 4 may cover the outboard-side surface of the second extension portion 22 of the window frame 12. The glass run 5 may be mounted on an internal peripheral edge portion of the frame molding 4.

The door weatherstrip 8 may be mounted on the window frame 12, and when the vehicle door closes the opening of the vehicle body, the door weatherstrip 8 may tightly contact with the vehicle body so that the vehicle door and the vehicle body may be sealed by the door weatherstrip 8. The vehicle body weatherstrip 9 may be mounted on the vehicle body, and when the vehicle door closes the opening of the vehicle body, the vehicle body weatherstrip 9 may tightly contact with the internal cover 7 of the window frame 12 so that the vehicle body and the vehicle door may be sealed by the vehicle body weatherstrip 9.

Referring to FIG. 13, the second extension portion 22 of the window frame 12 may include an external peripheral edge portion 35 extending in the external direction of the window frame 12, and an internal peripheral edge portion 36 extending in the internal direction of the window frame 12. The frame-side protrusion 16 may protrude from the external peripheral edge portion 35 toward the exterior of the vehicle, and the flat surface 16a of the frame-side protrusion 16 may contact with the frame molding 4 so that the second extension portion 22 of the window frame 12 may firmly support the frame molding 4 through the frame-side protrusion 16.

Referring to FIG. 13, a first internal support protrusion 38 and a second internal support protrusion 39 may be disposed on the internal peripheral edge portion 36 of the second extension portion 22. The first internal support protrusion 38 may contact with the internal peripheral edge portion of the frame molding 4 so that the second extension portion 22 may firmly support the frame molding 4 through the first internal support protrusion 38. The second internal support protrusion 39 may contact with the internal peripheral edge portion of the glass run 5 so that the second extension portion 22 may firmly support the glass run 5 through the second internal support protrusion 39. According to an exemplary embodiment of the present disclosure, a thickness t1 of the first internal support protrusion 38 may be less than a thickness t2 of the second internal support protrusion 39.

Referring to FIG. 14, an external panel 53 may be mounted on the outboard side of the door panel 11, and an external rail 54 may be fixed to the inboard side of the external panel 53. An external belt weatherstrip 51 may include a mounting groove 51a, and a top edge portion of the external panel 53 may be fitted into the mounting groove 51a of the external belt weatherstrip 51 so that the external belt weatherstrip 51 may be mounted on the top edge portion of the external panel 53. An internal belt weatherstrip 52 may include a mounting groove 52a, and the upper portion 23 of the door panel 11 may be fitted into the mounting groove 52a of the internal belt weatherstrip 52 so that the internal belt weatherstrip 52 may be mounted on the upper portion 23 of the door panel 11.

Referring to FIG. 14, the upper portion 23 of the door panel 11 may include a support edge portion 41 fitted into the mounting groove 52a of the internal belt weatherstrip 52. A height of the support edge portion 41 may correspond to that of an inboard-side surface of the internal belt weatherstrip 52.

The support edge portion 41 may include a first support portion 41a supporting an upper portion of the mounting groove 52a of the internal belt weatherstrip 52, and a second support portion 41b supporting a lower portion of the mounting groove 52a of the internal belt weatherstrip 52. According to an exemplary embodiment of the present disclosure, a thickness t3 of the first support portion 41a may be less than a thickness t4 of the second support portion 41b. The extension rib 42 provided on the upper portion of the door panel 11 may be located below the support edge portion 41.

The support edge portion 41 of the upper portion 23 of the door panel 11 may contact with the inboard-side surface of the internal belt weatherstrip 52 through the first support portion 41a and the second support portion 41b so that the upper portion 23 of the door panel 11 may firmly support the internal belt weatherstrip 52.

As set forth above, according to exemplary embodiments of the present disclosure, the door panel and the window frame may form a unitary one-piece structure by casting. The number of assembled components may be reduced so that variation in assembly tolerance may be reduced, and the degree of freedom in shaping and design may be increased, and thus the vehicle door performance may be improved.

According to exemplary embodiments of the present disclosure, as the door panel and the window frame form a unitary one-piece structure by casting, the thickness of the door panel and the thickness of the window frame may be relatively reduced, and accordingly the weight and material costs of the door body may be reduced.

According to exemplary embodiments of the present disclosure, the stiffness of the door body may be improved by increasing the thickness of a portion (section) of the door body.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the embodiments are used for describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A door body for a vehicle, the door body comprising:
a door panel including an opening defined in a center portion of the door panel; and
a window frame integrally connected to the door panel, and including a first extension portion and a second extension portion extending from the first extension portion, wherein the first and second extension portions define a glass opening,
wherein the door panel and the window frame form a unitary one-piece structure.

2. The door body of claim 1,
wherein the door panel further includes a plurality of panel-side ribs disposed on a periphery of the opening, and
wherein the plurality of panel-side ribs extend radially from a center portion of the opening.

3. The door body of claim 2,
wherein the door panel further includes a plurality of panel-side protrusions disposed on the periphery of the opening, and
wherein each panel-side protrusion protrudes from an outboard-side surface of the door panel toward an exterior of the vehicle.

4. The door body of claim 3, wherein a predetermined number of panel-side protrusions among the plurality of panel-side protrusions are individually connected to the plurality of panel-side ribs.

5. The door body of claim 3, wherein the door panel further includes an extension rib extending along the periphery of the opening.

6. The door body of claim 5, wherein the plurality of panel-side ribs are connected to the extension rib.

7. The door body of claim 1,
wherein the window frame further includes a plurality of frame-side protrusions disposed on a periphery of the glass opening, and
wherein each frame-side protrusion protrudes from an outboard-side surface of the window frame toward an exterior of the vehicle.

8. The door body of claim 7, wherein the window frame further includes a plurality of frame-side ribs disposed on the periphery of the glass opening.

9. The door body of claim 8,
wherein the plurality of frame-side ribs include a plurality of first frame-side ribs disposed on the first extension portion, and a plurality of second frame-side ribs disposed on the second extension portion, and
wherein the plurality of first frame-side ribs and the plurality of second frame-side ribs have different shape each other.

10. The door body of claim 9,
wherein each first frame-side rib is in a shape of “X”, and
wherein each second frame-side rib includes a straight shape extending in a longitudinal direction of the vehicle.

11. The door body of claim 9, wherein a predetermined number of frame-side protrusions among the plurality of frame-side protrusions are individually connected to the first frame-side ribs.

12. The door body of claim 9, wherein a predetermined number of frame-side protrusions among the plurality of frame-side protrusions are individually connected to the second frame-side ribs.

13. The door body of claim 7,
wherein the first extension portion of the window frame further includes an external peripheral edge portion extending in an external direction of the window frame from the frame-side protrusions, an internal peripheral edge portion extending in an internal direction of the window frame from the frame-side protrusions, an external support protrusion disposed on the external peripheral edge portion, and an internal support protrusion disposed on the internal peripheral edge portion, and
wherein the external support protrusion of the first extension portion is engaged to a glass run, and
wherein the internal support protrusion is engaged to the window frame.

14. The door body of claim 13,
wherein the external support protrusion includes a first support surface facing an external side of the window frame, a second support surface facing an internal side of the window frame, and a third support surface facing an outboard side of the window frame.

15. The door body of claim 14,
wherein a thickness of the external support protrusion is greater than a thickness of the external peripheral edge portion.

16. The door body of claim 13,
wherein the internal support protrusion includes a first support surface facing an outboard side of the window frame, and a second support surface facing an internal side of the window frame, and
wherein the first support surface supports an internal peripheral edge portion of the glass run, and the second support surface supports an internal peripheral edge portion of an internal cover.

17. The door body of claim 13, wherein at least a portion of a flat surface in each frame-side protrusion of the first extension portion contacts with an inboard-side surface of the glass run.

18. The door body of claim 1, wherein each extension portion includes:
wherein a first internal support protrusion and a second internal support protrusion are disposed on an internal peripheral edge portion of the second extension portion,
wherein the first internal support protrusion contacts with an internal peripheral edge portion of a frame molding so that the second extension portion supports the frame molding through the first internal support protrusion, and
wherein the second internal support protrusion contacts with an internal peripheral edge portion of a glass run so that the second extension portion supports the glass run through the second internal support protrusion.

19. The door body of claim 1, further including:
a partition rib provided on a portion of the door body; and
a first section and a second section partitioned by the partition rib,
wherein a thickness of the second section is greater than a thickness of the first section.
